(19) United States
(12) Patent Application Publication
(10) Pub. No.: US 2024/0275819 A1
(43) Pub. Date: Aug. 15, 2024

(54) SECURE SYSTEM FOR HIDING REGISTRATION RULES FOR DYNAMIC CLIENT REGISTRATION

(71) Applicant: International Business Machines Corporation, Armonk, NY (US)

(72) Inventors: Patrick Aaron Tamborski, Chicago, IL (US); Mark Duane Seaborn, Algonquin, IL (US)

(73) Assignee: International Business Machines Corporation, Armonk, NY (US)

(21) Appl. No.: 18/110,033

(22) Filed: Feb. 15, 2023

(51) Int. Cl. H04L 9/40; H04L 9/32

(52) U.S. Cl. CPC H04L 63/20; H04L 9/321; H04L 63/102

(57) ABSTRACT

A method to facilitate a permitted access to a protected resource associated with a service provider (SP). The method begins by the SP establishing a root of trust to a third party via an attribute-based encryption (ABE) master secret key, and a set of one or more public parameters. Once vetted by the entity, the SP receives a binary object from the third party that encodes the policy as a cryptographic payload. When a client application desires to enroll with and interoperate with the service provider, the SP receives a request for a credential. The request has an associated (ABE) user key generated by the third party according to the policy. The service provider determines whether the binary object obtained during the initial vetting process can be decrypted using the ABE user key and the public parameters and the ABE user key. If so, and provided it has obtained any other necessary permission, the service provider issues the credential to the client application.

### BACKGROUND OF THE INVENTION

### Technical Field

This disclosure relates generally to network security and more specifically to a system that uses attribute-based encryption (ABE) as a mechanism of specifying trust between service providers that need to share client resources.

### Background of the Related Art

User authentication and authorization are critical components of network security. For example, authenticating a user's identity is a first step in providing control for accessing secure user accounts, performing secure transactions, accessing secure network resources, and the like, by a user. Authentication is the process of confirming the user's identity, while authorization is the process of granting permission to the user. Authorization is the function of specifying access rights or privileges to secure or protected resources, which is related to access control. Authorization is defined by access control policies. During an authorization operation, the computer system uses the access control policies to determine whether protected resource access requests from authenticated users are approved (i.e., granted access) or disapproved (i.e., denied access). Network security consists of these access control policies adopted to prevent and monitor unauthorized access, misuse, modification, or denial of network-accessible protected resources.

A common operating scenario in the industry today involves a service provider (SP) that owns some data for a customer, and wherein the customer wants to share that data with another service provider for processing. Appropriate network security mechanisms such as described above are assumed to be in place for at least some of the participants. In this scenario, the second service provider may be deemed a client application (CA) of the first service provider. While these types of service provider-to-service provider interactions provide significant efficiencies for end users, client applications (CAs) operating in this manner need a good way to enroll with service providers (SPs) that may not want to own any vetting process for ensuring that the service provider is a legitimate business.

Systems that enable vetting of service providers for certain purposes are known in the art. In one known vetting approach, a cloud-based key management system is provided to store, retrieve, generate and perform key operations. A company uses this system to manage, audit, and maintain control and security around their keys. The system includes an identity vetting service to verify the identity and/or authorization of a key requester, and the vetting may include accessing a policy engine to determine the rights of the requester. The level of vetting provided depends on the requester, the value of the keys, and the requested key function. In another known technique, a vetting service is secured by not allowing a “relying” party to write the entire screen of application, thereby enabling a security component to frustrate a “man in the middle” attack, i.e., allowing a perpetrator to simulate action of a legitimate system. The approach is enabled by a security component that is associated with a network-enabled application. In operation, the security component initiates the display of an embedded region of a window drawn according to display information received from a relying party. The security component defines at least a portion of the appearance of the embedded region, but the relying party may not define this portion. The security component sends the address of the relying party to a reputation service and queries the reputation service about the reputation of the relying party. The reputation service then returns reputation information about the relying party. If the reputation information indicates the relying party is reputable, the security component allows the network-enabled application to exchange information with the relying party.

While service provider vetting such as described above is known, there remains a need to provide improved techniques to ensure identity providers that a given entity has been vetted by a trusted vetting service.

### BRIEF SUMMARY

According to this disclosure, a method, apparatus and computer program product are provided to facilitate a permitted access to a protected resource associated with a service provider (SP). The permitted access is defined by a security policy comprising one or more rules that define a registration requirement for obtaining a credential, and wherein the credential is required for use to access the protected resource.

In a representative embodiment, a method to permit such access is carried out by a service provider. The method begins by the service provider establishing a root of trust to a third party entity, the root of trust being represented by an attribute-based encryption (ABE) master secret key retained by the third party entity, and a set of one or more public parameters of an associated ABE master public key. This third party entity provides a “vetting” service. Once the service provider has been vetted, it receives a binary object from the third party entity. The third party generates the binary object as a cryptographic object by applying the ABE master public key to the one or more rules of the policy (expressed as Boolean predicates), thereby encoding the policy as a cryptographic payload. Thereafter, it is assumed that a client application (e.g., another service provider) desires to enroll with and interoperate with the service provider. To this end, the service provider receives (either directly or indirectly) a request from the client application for the credential. The request has associated therewith an attribute-based encryption user key, the ABE user key having been generated by the third party entity according to the policy and including one or more attributes required by the policy. The service provider then determines whether the binary object that it obtained during the initial vetting process can be decrypted using the one or more public parameters and the ABE user key. If so, the service provider issues the credential to the client application. The client application then uses the credential to access the protected resource, but does so without ever receiving or having access to the service provider's security policy. At all times, the one or more registration rules of that policy remain obfuscated by being encoded within the cryptographic payload of the binary object.

The foregoing has outlined some of the more pertinent features of the disclosed subject matter. These features should be construed to be merely illustrative. Many other beneficial results can be attained by applying the disclosed subject matter in a different manner or by modifying the subject matter, as will be described below.

### BRIEF DESCRIPTION OF THE DRAWINGS

For a more complete understanding of the subject matter herein and the advantages thereof, reference is now made to the following descriptions taken in conjunction with the accompanying drawings, in which:

FIG. 1 depicts an exemplary block diagram of a data processing system in which exemplary aspects of the illustrative embodiments may be implemented;

FIG. 2 depicts a known technique by which an attribute-based encryption mechanism may be used to facilitate access to a protected resource in a computing system;

FIG. 3 depicts a representative process flow by which a service provider enrolls with a third party vetting service (TPVS) according to this disclosure;

FIG. 4 depicts a first embodiment wherein a client application interacts with a third party vetting service directly to enroll with and obtain a credential that enables interaction with a target service provider; and

FIG. 5 directs a second embodiment wherein a client application interacts with a third party vetting service indirectly (e.g., via SP-redirect) to enroll with and obtain a credential that enables interaction with the target service provider.

### DETAILED DESCRIPTION OF AN ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as attribute-based encryption enrollment and utilization code 200 of this disclosure that facilitates the ability of a client application to enroll with and interoperate with a target service provider without having access to the one or more rules of an access or other security policy of the target service provider. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

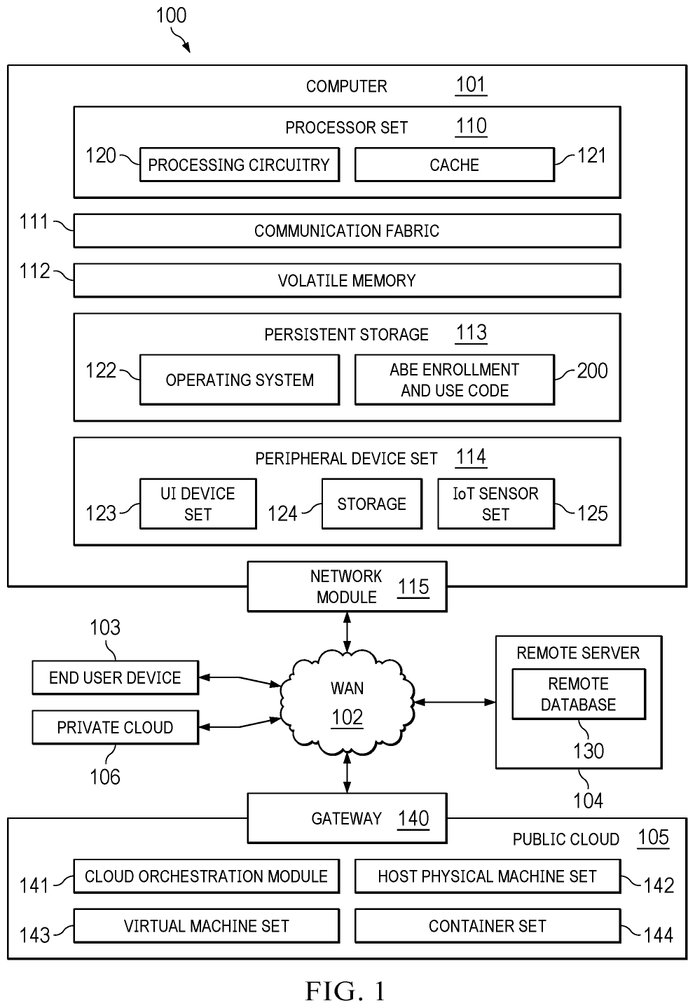

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as Linux, various known proprietary operating systems or open source Portable Operating System Interface-type operating systems that employ a kernel. The code included in block 200 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Network Security

By way of further background, and as described above, user authentication and authorization are critical components of network security. For example, authenticating a user's identity is a first step in providing control for accessing secure user accounts, performing secure transactions, accessing secure network resources, and the like, by a user. Authentication is the process of confirming the user's identity, while authorization is the process of granting permission to the user. In other words, authentication is the process of verifying who the user is, while authorization is the process of verifying what the user can perform or have access to. Authorization is the function of specifying access rights or privileges to secure or protected resources, which is related to access control. Authorization is defined by access control policies. During an authorization operation, the computer system uses the access control policies to determine whether protected resource access requests from authenticated users are approved (i.e., granted access) or disapproved (i.e., denied access). Protected resources can include, for example, data containing confidential or sensitive information, files, documents, software applications and programs, storage, processors, memory, network resources, and the like. Logically, authentication precedes authorization.

Generalizing, network security consists of these access control policies adopted to prevent and monitor unauthorized access, misuse, modification, or denial of network-accessible protected resources. Typically, users choose or are assigned an identifier, such as a user name, and a password or other authenticating information that allows the users access to the network-accessible protected resources within the users' authority. For example, once authenticated, a firewall enforces the access control policies that define what protected resources on the network respective users are allowed to access.

### Attribute Based Encryption

As has been described, computer systems that share protected resources, such as confidential data, between service providers and customers (i.e., resource users) are numerous on the Internet today. One challenging issue of this provider/customer model is user authentication and authorization. There are a number of ways to implement user authentication and authorization. Some of the newer methods, however, allow the implementation to protect the access control policies by encrypting the access control policies, along with the protected data using functional encryption.

One of these newer methods is attribute-based encryption, where protected data are encrypted and made available to any user and the implementation relies on the cryptographic strength of the algorithm to obfuscate the protected data and Boolean predicates (e.g., access control policies) encrypted within the ciphertext as protection against unauthorized user access of the protected data. Attribute-based encryption is a type of public-key encryption (PKE) in which a secret cryptographic key of a user and ciphertext are dependent upon attributes of the user, such as, for example, the geographic location where the user works, job title of the user, job roles of the user, resource group the user is a member of, security level of the user, and the like. In attribute-based encryption, the decryption of the ciphertext is possible only if the set of attributes of the user key matches the attributes of the ciphertext. There are two main types of attribute-based encryption techniques: (1) key-policy attribute-based encryption; and (2) ciphertext-policy attribute-based encryption.

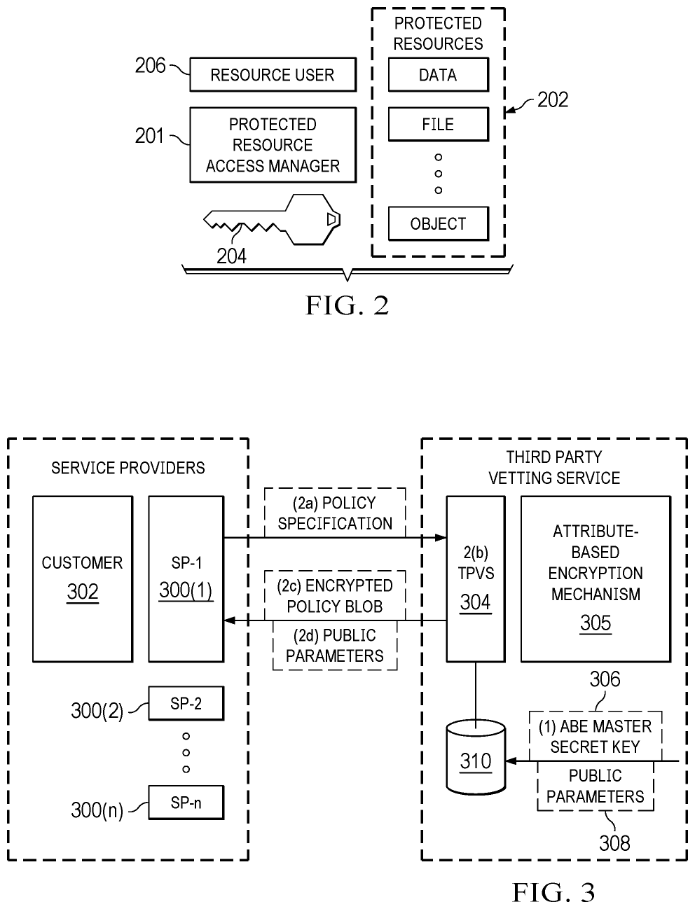

FIG. 2 depicts a representative implementation of an ABE-based protection mechanism. In this example, a protected resource access manager 201 controls resource user access to a set of protected resources 202. To this end, protected resource access manager 201 utilizes an attribute-based encryption user key 204 as a secret cryptographic key to generate a key-hash message authentication code digital signature over a set of header fields of a protected resource access request made by a resource user 206 requesting access to a particular protected resource in the set of protected resources. Protected resource access manager 201 compares the generated authentication code digital signature with an authentication code digital signature received in an embedded header field of the protected resource access request to authenticate the resource user 206. Upon authentication of the resource user 206 by determining that a match exists between the authentication code digital signatures, protected resource access manager 201 utilizes the same attribute-based encryption user key 204 used to generate the authentication code digital signature received in the embedded header field of the protected resource access request to decrypt the requested protected resource or metadata corresponding to the requested protected resource. If decryption is successful using that particular attribute-based encryption user key, then protected resource access manager 201 determines that the resource user is authorized to access that particular protected resource and grants access.

### Secure System for Hiding Registration Rules for Dynamic Client Registration

With the above as background, the technique of this disclosure is now described. A representative operating environment in which the technique is practiced is shown in FIG. 3. In this operating environment, it is assumed that some (first) service provider (SP) 300(1) owns some data for a customer 302, which customer wants to share that data with another (second) service provider 300(2) for processing. The second service provider 300(2) may be deemed a client application (CA) of the first service provider 300(1), in which case it may be useful to think of the first service provider as a “target service provider.” In this solution, a third party vetting service (TPVS) 304 is provided to enable the SP/CA 300(2) to enroll with the service provider 300(1). In one embodiment, the TPVS operates as a network-accessible managed service (e.g. as Software-as-a-Service), although the TPVS may also be implemented as a software-based process associated with some other hardware-based security solution, system, device, appliance or mechanism. In a representative implementation, TPVS is implemented in a cloud-accessible computing system such as depicted in FIG. 1. More generally, TPVS 304 provides a vetting service by which CAs enroll with one or more service providers. Thus, and as depicted in FIG. 3, typically there are multiple SPs (e.g., 300)(1-n), and the TPVS 304. Not all SPs 300 have to have the same security policy and, typically, each SP has a different security policy. A given policy can be use case-specific. Generalizing still further, the CA does not need to be an SP for a generic case.

According to this disclosure, the TPVS 304 utilizes attribute-based encryption (ABE) 305 as the mechanism used to specify trust between service providers that need to share client resources, such as the data hosted by or otherwise associated with the first service provider 300(1) that the customer 302 desires to have processed by the second service provider 300(2). A preferred workflow starts with a service provider (that seeks to obtain the benefits of the vetting service) enrolling with the service. This process is sometimes referred to herein as an SP initializing trust. To this end, and as depicted in FIG. 3, at step (1) the TPVS 304 creates an ABE master secret key 306 and public parameters 308 for a root of trust in the system. The ABE master secret key 306 is stored in a trusted data store, such as a hardware enclave 310. Assume now that an SP (e.g., SP 300(1), 300(2), or any other SP) desires to enroll with the TPVS 304.

FIG. 3 also depicts the SP 300 enrolling as an SP with the TPVS 304 by carrying out the following sub-steps. A step (2a), the SP 300 and TPVS 304 collaborate to create a policy that meets both of their requirements. Typically, a policy comprises a set of rules that may be specified in a configurable manner, e.g., such as a rule tree. The nature and syntax of a given rule (and thus the policy) may vary depending on implementation, and the nature and scope of the collaboration between the SP and the TPVS also may vary, but with the overarching goal that that the SP provides sufficient proof to the TPVS that it operates in a manner that is compliant with the one or more rules of the policy. Thus, in one example embodiment, the rules specific certain geographic, temporal, or other requirements that must be met, such as the SP providing proof that it operates within a geographic boundary, that it has been in business over some given time period, that it has certain regulatory and compliance systems in place, and so forth. There is no limit to the one or more conditions that an SP is required to meet to be trusted.

Referring back to FIG. 3, and assuming that the enrolling SP 300 has provided sufficient proof to the TPVS that the one or more rules required by the policy are met, at step 2(b) the TPVS 304 encodes one or more attributes of the policy using ABE Boolean logic and applies an ABE master public key to the result to generate an encrypted blob 312. In this manner, the one or more rules of the policy are hidden (encoded) inside the payload of the blob. At step (2c), the TPVS 304 transmits the encrypted blob 312 to the SP 300 over a secure channel. At step (2d), the TPVS 304 transmits the public parameters 308 for the ABE master secret key 306 to the SP over the secure channel. Steps (2c) and (2d) may be combined, and one or more secure channels may be used. This completes the on-boarding (vetting) process for the SP. As a skilled person will appreciate, this vetting process is used simply to identify that the SP 300 is a valid SP, as opposed to some malicious entity trying to break into the trust boundary for the SPs; access to data owned by an SP (in FIG. 3, this is SP 300(1)) is still subject to standard access control mechanisms.

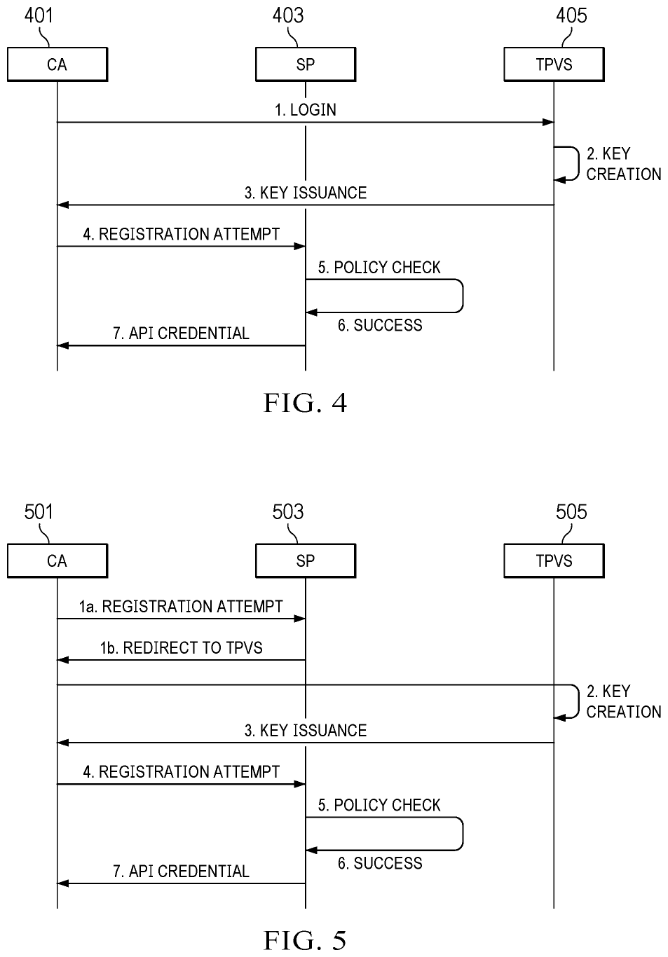

FIG. 4 depicts the process flow by which the system uses ABE as the mechanism of specifying trust between first and second service providers that need to share client resources. In a representative use case, there is a client application (associated with the second service provider) 401 that has identified a first service provider 403 that it, the CA, desires to enroll with, e.g., to obtain access to data of a customer associated with the first service provider. In this embodiment, the CA 401 has knowledge of the existence of the TPVS 405.

Referring to FIG. 4, the process for the requesting client application 401 to obtain a credential begins at step (1) when the client application 401 logs into a TPVS 405 portal and identifies an SP it wishes to enroll with. In one typical embodiment, this is accomplished via a user interface (UI) that include a drop-down list of the available SPs, although the particular nature of the portal is outside the scope of this disclosure. Programmatic interaction (e.g., via a suitable API) may be used for this purpose. In this example embodiment, and upon entry of an SP selection by the client application, at step (2) the TPVS 405 creates an ABE user key with one or more attributes that are required to meet the SP's policy demands (i.e., the one or more rules specified thereby). As noted above, the nature of the rules required by the policy would have been negotiated between the SP and TPVS during the SP vetting process. At step (3), the TPVS 405 issues the ABE user key to the requesting client application 401. At step (4), the client presents this ABE user key to the SP 403. At step (5), the SP 403 attempts to use the user key presented by the client and the public parameters (received at step 2(d) in FIG. 3) to decrypt the encrypted blob that was acquired by the SP 403 during its enrollment with the TPVS 405. At step (6), and if the user key combined with the public key parameters successfully decrypts the blob, the SP 403 knows that the client application has acquired a credential from the TPVS 405 that matches the SP's policy; and, as a consequence, that the SP 403 can trust the client application. Accordingly, and as step (7), the SP then issues any credential needed for the client application 401, e.g., to use APIs or other programmatic mechanisms, on the SP 403, thereby enabling the CA to obtain data (or other resources) from the SP.

The above-described process flow ensures that the service provider does not allow the data owner to be spoofed into believing that the CA is a legitimate service. Before the service provider issues the credential (step (7)), however, the service provider also has to obtain consent of the data owner to process the owner's data. This consent may be obtained using an access control (e.g., as done in OIDC).

In an alternative embodiment, which is depicted in FIG. 5, the client application 501 does not know about the TPVS and instead interacts first with the service provider 503. To this end, and at step (1a), the client application 501 attempts to register to the SP 503, e.g., using a predefined or configured registration procedure. The nature of the registration is outside the scope of this disclosure; a representative registration may involve simple presentation of a client identifier and password. At step (1b), the SP 503, as part of its response to the client application, redirects the client application (e.g., via an HTTP 302 redirect) to the TPVS that the client must then use. The rest of the flow proceeds exactly as in the direct flow depicted in FIG. 4 and described above. Thus, at step (2) the TPVS 505 creates an ABE user key with one or more attributes that are required to meet the SP's policy demands/ At step (3), the TPVS 505 issues the ABE user key to the requesting client application 501. At step (4), the client presents this ABE user key to the SP 503. At step (5), the SP 503 attempts to use the user key presented by the client and the public parameters to decrypt the encrypted blob that was acquired by the SP 503 during its enrollment with the TPVS 505. At step (6), and if the user key combined with the public key parameters successfully decrypts the blob, the SP 503 knows that the client application has acquired a credential from the TPVS that matches the SP's policy and, as a consequence, that the SP 503 can trust the client application. Accordingly, and once again assuming the service provider also has the necessary permission to process the owner's data, the flow then continues at step (7). At this step, the SP then issues any credential needed for the client application 501, e.g., to use APIs or other programmatic mechanisms, on the SP 503, once again enabling the CA to obtain data (or other resources) from the SP.

The technique of this disclosure provides significant advantages. As has been described, attribute-based encryption is used as the preferred mechanism of specifying trust between service providers that need to share client resources. ABE as described and utilized herein enables the participating service providers to hide and verify policy for enrolling clients into services offered by third-parties. By encapsulating the particular details of a given policy within the cryptographic payload itself, the policy itself is never returned to the requesting client application, although that client application is enabled to register to the target service provider dynamically (and to interact therewith thereafter). The approach enables complete hiding of the rules of a policy of the target service provider while still enable seamless and dynamic provisioning of the client application that seeks to interoperate with the service provider.

Generalizing, the method according to this disclosure may be implemented as a standalone approach, e.g., a software-based function executed by a processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed subject matter are each a data processing system (such as shown in FIG. 1) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

As also depicted in FIG. 1, the scheme described herein may be implemented in or in conjunction with various server-side architectures including simple n-tier architectures, web portals, federated systems, and the like. The techniques herein may also be practiced in whole or in part in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the analytics engine functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

In a representative embodiment, the vetting system and the attribute-based encryption enrollment and utilization code are implemented in a special purpose computer, preferably in software executed by one or more processors. The software is maintained in one or more data stores or memories associated with the one or more processors, and the software may be implemented as one or more computer programs. Collectively, this special-purpose hardware and software comprises the system described above.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

The approach herein may be implemented in key-policy based ABE, in ciphertext-policy based ABE, in any other ABE derivative, or in any similar cryptographic scheme.

In a variant embodiment, the roles of the SP and CA can be reversed with respect to the above-described operation; in this case, the TPVS provides the binary object to the CA, while the SP receives the ABE user key. The decryption function works in the same manner as previously described.

The techniques herein provide for improvements to another technology or technical field, namely, provider-to-provider onboarding and access control systems, as well as improvements to the operational capabilities of such systems when used in the manner described.

The nature of the data that is being accessed by the client application, as well as the particular manner by which the client application interoperates with the service provider following receipt of the credential, are implementation-specific and are not a limitation of this disclosure.

Having described the subject matter, what is claimed is as follows.

1. A method to enable permitted access to a protected resource associated with a service provider (SP), wherein permitted access is defined by a security policy comprising one or more rules that define a registration requirement for obtaining a credential, the credential required for use to access the protected resource, comprising:
receiving a binary object, the binary object having been generated by an entity applying an attribute-based encryption (ABE) key to the one or more rules of the policy, expressed as Boolean predicates;
receiving a request for the credential, the request having associated therewith an ABE user key, the ABE user key having been generated by the entity according to the policy and including one or more attributes required by the policy;
determining whether the binary object can be decrypted using the ABE key and one or more public parameters; and
upon a determination that the binary object can be decrypted, issuing the credential.

2. The method as described in claim 1 wherein the request for the credential is received from a client application.

3. The method as described in claim 2 wherein the client application is associated with a second service provider.

4. The method as described in claim 3 further including:
receiving a request to access the protected resource from the client application; and
returning the protected resource to the client application.

5. The method as described in claim 1 wherein the entity is a third party vetting service.

6. The method as described in claim 1 further including establishing a root of trust to the entity, the root of trust being represented by an ABE master secret key, and the set of one or more public parameters.

7. The method as described in claim 6 further including determining that the service provider has permission from a resource owner to access the protected resource prior to issuing the credential.

8. An apparatus associated with a service provider (SP), comprising:
a processor;
computer memory holding computer program instructions executed by the processor to enable permitted access to a protected resource associated with the SP, wherein permitted access is defined by a security policy comprising one or more rules that define a registration requirement for obtaining a credential, the credential required for use to access the protected resource, the computer program instructions comprising program code configured to:
receive a binary object, the binary object having been generated by an entity applying an attribute-based encryption (ABE) key to the one or more rules of the policy, expressed as Boolean predicates;
receive a request for the credential, the request having associated therewith an ABE user key, the ABE user key having been generated by the entity according to the policy and including one or more attributes required by the policy;
determine whether the binary object can be decrypted using the ABE user key, and one or more public parameters; and
upon a determination that the binary object can be decrypted, issue the credential.

9. The apparatus as described in claim 8 wherein the request for the credential is received from a client application.

10. The apparatus as described in claim 9 wherein the client application is associated with a second service provider.

11. The apparatus as described in claim 10 wherein the program code is further configured to:
receive a request to access the protected resource from the client application; and
return the protected resource to the client application.

12. The apparatus as described in claim 8 wherein the entity is a third party vetting service.

13. The apparatus as described in claim 8 wherein the program code is further configured to:
establish a root of trust to the entity, the root of trust being represented by an ABE master secret key, and the set of one or more public parameters.

14. The apparatus as described in claim 13 wherein the program code is further configured to determine that the service provider has permission from a resource owner to access the protected resource prior to issuing the credential.

15. A computer program product in a non-transitory computer readable medium, the computer program product holding computer program instructions executed by a processor in a host processing system associated with a service provider (SP) to enable permitted access to a protected resource associated with the SP, wherein permitted access is defined by a security policy comprising one or more rules that define a registration requirement for obtaining a credential, the credential required for use to access the protected resource, the computer program instructions comprising program code configured to:
receive a binary object, the binary object having been generated by an entity applying an attribute-based encryption (ABE) key to the one or more rules of the policy, expressed as Boolean predicates;
receive a request for the credential, the request having associated therewith an ABE user key, the ABE user key having been generated by the entity according to the policy and including one or more attributes required by the policy;
determine whether the binary object can be decrypted using the ABE user key, and one or more public parameters; and
upon a determination that the binary object can be decrypted, issue the credential.

16. The computer program product as described in claim 15 wherein the request for the credential is received from a client application.

17. The computer program product as described in claim 16 wherein the client application is associated with a second service provider.

18. The computer program product as described in claim 17 wherein the program code is further configured to:
receive a request to access the protected resource from the client application; and
return the protected resource to the client application.

19. The computer program product as described in claim 15 wherein the program code is further configured to:
establish a root of trust to the entity, the root of trust being represented by an ABE master secret key, and the set of one or more public parameters.

20. The computer program product as described in claim 19 wherein the program code is further configured to determine that the service provider has permission from a resource owner to access the protected resource prior to issuing the credential.
